(19) United States
(12) Patent Application Publication
(10) Pub. No.: US 2012/0081057 A1
(43) Pub. Date: Apr. 5, 2012

(54) METHOD FOR OPERATING AN ACTUATOR

(75) Inventor: Stefan Schwamberger, Lohsa Ot. Hermsdorf (DE)

(73) Assignee: MINEBEA CO., LTD, NAGANO-KEN (JP)

(21) Appl. No.: 13/239,900

(22) Filed: Sep. 22, 2011

(30) Foreign Application Priority Data
Sep. 30, 2010 (DE) 10 2010 047 148.8

(51) Int. Cl. H02P 1/02; F16K 31/02

(52) U.S. Cl. 318/478; 137/624.11

(57) ABSTRACT

A method for operating an electrically driven actuator having a power supply that has an energy storage unit (7) is provided. At the energy storage unit, an energy quantity meter (8) continuously adds up the amount of energy stored and withdrawn. An actuating process is only carried out when there is sufficient energy available in the energy storage unit to carry out the actuating process in full.

### CROSS-REFERENCE TO RELATED APPLICATIONS

This application claims the benefit of German Patent Application No. DE 10 2010 047 148.8, filed Sep. 30, 2011, which is incorporated herein by reference as if fully set forth.

### BACKGROUND

The invention describes a method and a device for operating an electrically driven actuator having a power supply that has an energy storage unit.

This kind of control element may have an electromagnetically or electrochemically operated actuator that is not permanently moved but rather only moved in response to a command and may, for example, take the form of a valve in a fluid conduit that can either block or release the flow of fluid.

Since the energy storage unit can only provide a finite amount of electrical energy, there is a chance that the energy storage unit is emptied during an ongoing actuating process thus causing the actuating process to be terminated. The actuator is then in an undefined state and as such can only be moved directly by mechanical or manual means, or else the energy storage unit has first to be supplied with an external source of electrical energy. The actuator has then to be re-initialized with the original actuating process not being fully completed.

A particular problem, for example, is the complete closure of a valve when the energy for the actuating movement of the valve is derived from the through-flow or the thermal capacity of a flowing medium if there is not sufficient energy available in the energy storage unit to reopen the valve.

### SUMMARY

The object of the invention is thus to provide a device and a method for operating an actuator of the kind mentioned above in which no undefined states can occur.

This object has been achieved according to the invention by a method in which the amount of energy available in the energy storage unit is first determined and an actuating process is only carried out when there is enough energy in the energy storage unit to fully implement the actuating process as well as any subsequent processes, such as the re-opening of a valve after an awaited closing process.

The energy storage unit may take the form, for example, of an accumulator, a battery, a capacitor, a thin film cell or suchlike. The amount of energy contained in the energy storage unit can be determined through metering or by any other suitable means. The amount of energy may, for example, be determined on demand. However, it is preferable if the amount of energy is determined on a continuous basis.

In the case of rechargeable energy storage units, an energy quantity meter can count the amount of energy flowing into the energy storage unit during recharging. For exchangeable energy storage units, either the primary amount of energy contained therein has to be previously known, which may, for example, appear on the energy storage unit as readable information, or the energy contained in the energy storage unit is determined during operation using appropriate means, analogous to a rechargeable energy storage unit.

Moreover, it is also possible for the energy quantity meter to continuously meter the amount of energy withdrawn from the energy storage unit during operation and hence calculate the amount of energy still available in the storage unit.

In an advantageous embodiment of the invention, an energy quantity meter continuously adds up the amount of energy fed in and withdrawn to determine the available amount of energy in the energy storage unit. Here, any self-discharge of the energy storage unit can be taken into account.

To allow an actuating command to be carried out, the amount of energy available in the storage unit has now to be greater than the amount of energy needed for the actuating process as well as for any other processes, such as a metering process. The required amount of energy may, for example, be filed in a table in a digital information storage device.

Alternatively, the amount of energy needed for an actuating process, even during first implementation of an actuating process, may be measured and this measured value stored in a table for later use. It is preferable if pairs of values consisting of the actuating path and the required amount of energy are stored.

In addition, the invention comprises a device that has an energy converter to convert ambient energy into electrical energy, the energy collected being stored in the energy storage unit and the energy quantity meter monitoring the stored energy.

The device is thus independent of external sources of energy since it derives its required energy from the environment. The energy converter can, for example, convert thermal energy, electromagnetic energy, such as light, or mechanical or kinetic energy, such as sound waves, oscillations and vibrations or any other ambient energy into electrical energy.

The device may be designed for connection to an external actuator, the actuator being connected to the device by means, for example, of a cable. It is advantageous, however, if the device and the actuator are disposed in a common housing thus creating a compact, maintenance-free actuator.

### BRIEF DESCRIPTION OF THE DRAWINGS

The invention is described in more detail below using a radiator valve as an example with reference to the attached drawings, the invention being by no means restricted to this application.

In the drawings:

FIG. 1 is a block diagram of a radiator valve according to the invention,

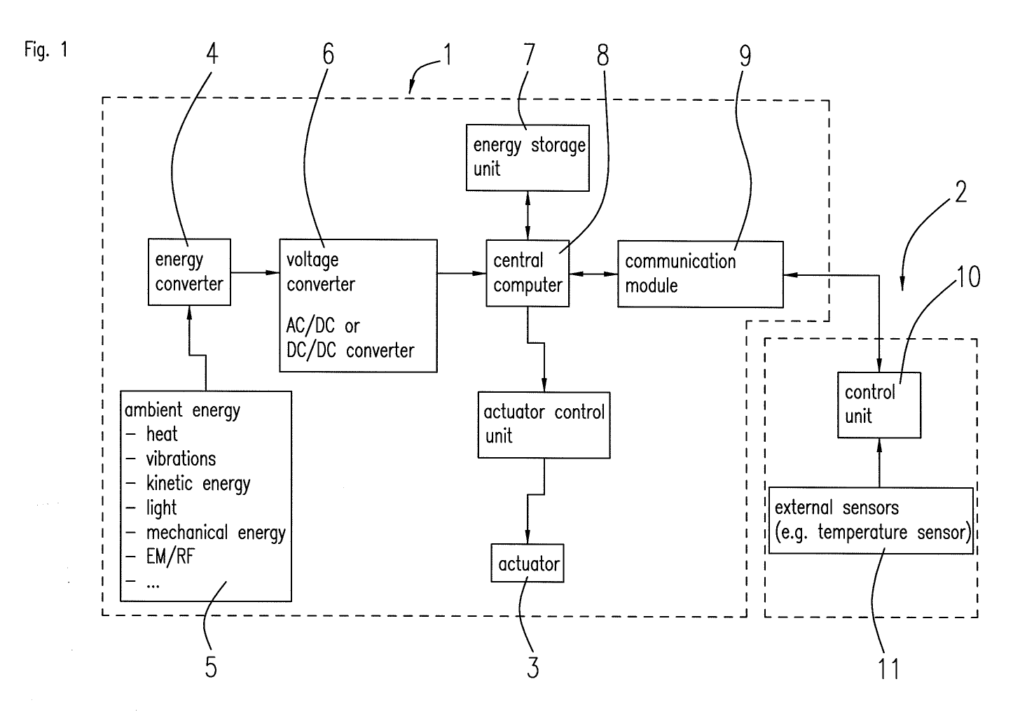

FIG. 2 is a flowchart of the method according to the invention using the radiator valve as an example, and

FIG. 3 a flowchart of an alternative method according to the invention.

### DETAILED DESCRIPTION OF THE PREFERRED EMBODIMENTS

The radiator valve 1 according to the invention has a valve having a preferably linearly movable actuator 3 that can be moved, for instance, by an electromagnetic drive.

For its power supply, the radiator valve 1 has an energy converter 4 that can convert ambient energy 5, thermal energy in the example, into electrical energy. For this purpose, the energy converter 4 is based, for example, on the Peltier or Seebeck effect, where a difference in temperature is converted into an electrical potential. The electrical energy generated is processed in a voltage converter 6 and stored in an energy storage unit 7. This energy storage unit 7 takes the form, for example, of an accumulator. The energy storage unit may, however, be a capacitor or any other electrical energy storage unit.

The radiator valve 1 also has an energy quantity meter that is realized in a microprocessor or a microcontroller 8. With the aid of sensors, the energy quantity meter 8 monitors the amount of energy stored by the energy converter 4 in the energy storage unit 7 and the amount withdrawn. By continuously adding up (integrating) the two amounts of energy, the amount of energy still contained in the energy storage unit can be determined. Alternatively, the energy content of the energy storage unit is directly determined, by measuring, for instance, the voltage at a storage capacitor.

In the event that the energy storage unit 7 is empty and there is no heat available as a source of energy 5, the radiator valve 1 may have externally contactable connections by which the energy storage unit can be recharged from an external voltage source (not illustrated). This amount of energy is also measured by the energy quantity meter 8.

Furthermore, the radiator valve 1 has a communication module 9 having an interface via which control commands can be received. In the example, the control commands are transmitted wirelessly from an external control device 2. Alongside a control unit 10, the control device 2 has external sensors, such as a temperature sensor 11 that measures room temperature.

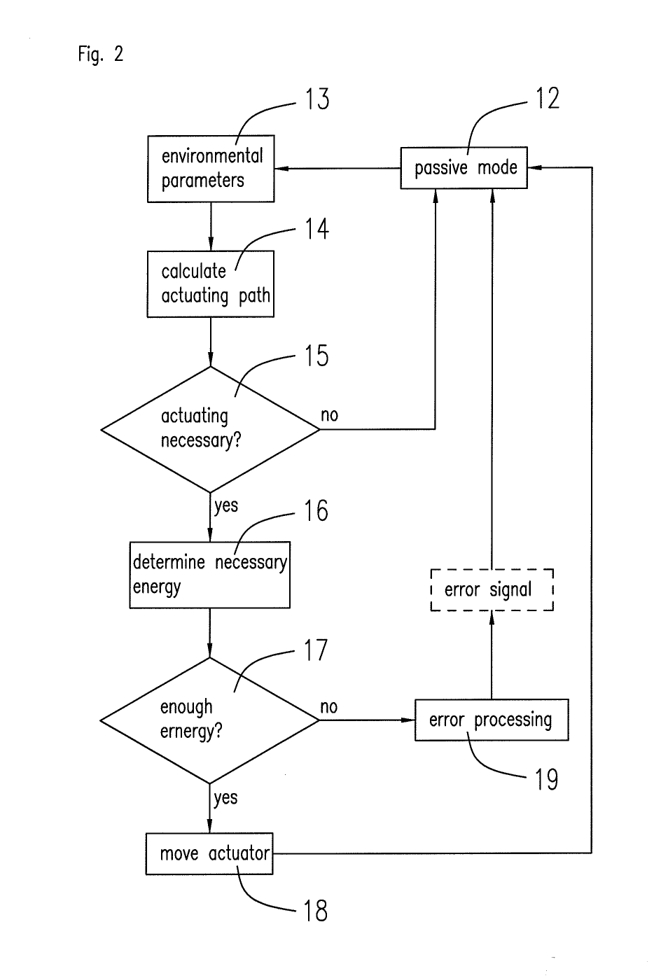

The course of an actuating process is illustrated by way of example in FIG. 2. For most of the time, the radiator valve 1 is in a passive or standby mode 12. Here, as much electrical energy as possible is fed by the energy converter 4 into the energy storage unit 7. Only the communication module 9 checks for any actuating command.

The control unit 10 continuously compares the room temperature measured by the temperature sensor 11 to a predetermined target value 13 in the control unit. From a difference in temperature, the control unit calculates an actuating path for the actuator 3 of the valve 14. This value is transmitted to the communication module 9.

Depending on the actual actuator position, the central computer 8 now decides whether an actuating process 15 is required. If no movement is necessary, then it passes back into the passive mode 12.

If a movement of the valve is required, it is first determined how much electrical energy 16 is needed for this actuating process 15. For this purpose, the processor 8 is provided with a table in which the amount of energy needed for some or for all actuating distances is stored accordingly. The exact value may possibly have to be interpolated or extrapolated from known neighboring values. For this purpose, the values have to be experimentally determined in a one-off process and loaded, for example, onto a hard disk.

Alternatively, should the actuating path and the necessary amount of energy for this path be proportional to one another, the amount of energy needed for the actuating process may be calculated by the product of the target actuating path multiplied by the quotient of the energy that is needed for the overall adjustment path divided by the overall actuating path.

The table may be contained, for example, in the microprocessor 8 or in the actuator, the device according to the invention having an interface for reading the table. However, the table may also be disposed in the device itself, it being possible for several tables for various controlled actuators to be provided if needed.

Alternatively, the amount of energy needed for a specific actuating path may also be determined during the first or during every process or, for example, during every tenth process and stored for future use. For this purpose, only the amount of energy withdrawn from the energy storage unit during the actuating process, together with the actuating path, need be stored in the table.

The required amount of energy is now subtracted from the actual amount of energy 16 available in the energy storage unit. In the example, the actual amount of energy is readily available in the energy quantity meter 8. In other embodiments, the available amount of energy may also be especially determined or measured. If the remaining amount is positive, this means there is more energy available than required and the actuating process is carried out in full. The actuator is moved into the desired position 18. The system then returns to the passive mode 12.

The advantage compared to the prior art lies in the fact that the actuating process is now always carried out in full. At most there is only a delay in implementation should sufficient energy not be immediately available.

Should the amount of energy in the energy storage unit be insufficient, an error signal may, for example, be sent. Or, for example, the procedure can be delayed until the energy converter has stored enough energy in the storage unit.

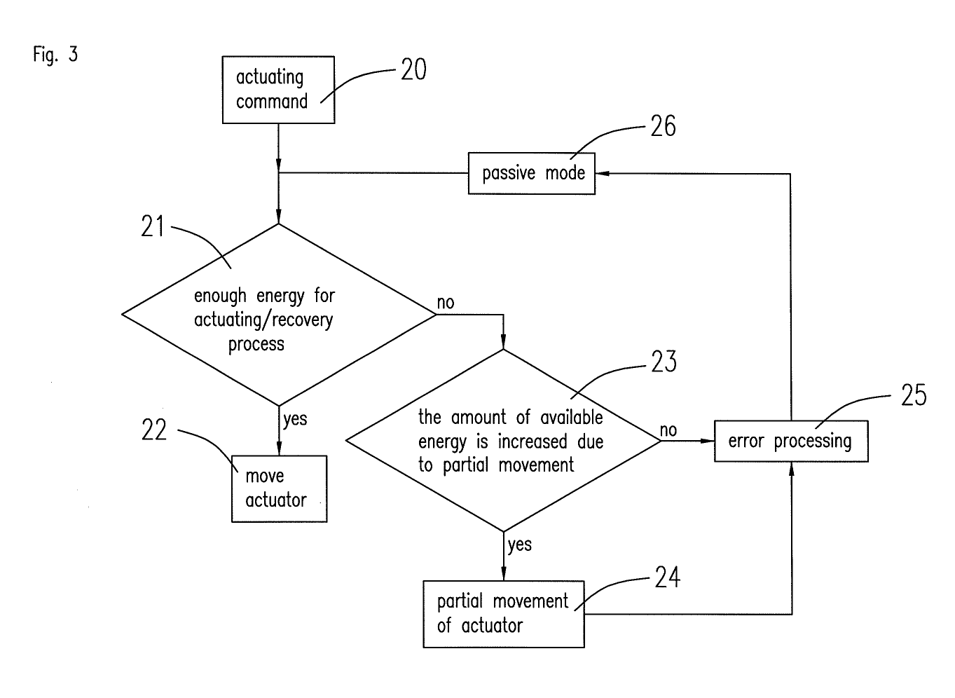

Alternatively, it is also conceivable for the actuator to initially be moved to the extent that the energy lasts. As soon as the energy storage unit provides the remaining energy, from the energy converter, for example, the actuating process is resumed and completed. Such a method is outlined, for example, in the flowchart of FIG. 3. Here again, an initial check is made to see whether there is enough energy to carry out the actuating command 20 and any possible recovery process 21 (see below). Should this be the case, the actuator is moved to the required position 22. However, if not enough energy is available, first a check is made 23 to see if a partial movement of the actuator using the currently available energy would result, following this partial movement, in the energy converter having expectably more energy available for conversion purposes. Should this be the case, first the actuator is partially moved as far as the existing energy in the energy storage unit 24 allows. This makes it possible for the energy storage unit to be charged at a faster rate and for the desired movement to be completed sooner.

If this is not the case, error processing 25 is called up and the energy determination 21 is repeated after a waiting time 26.

This makes it possible for an actuating process to be only partially carried out in a controlled manner. This is particularly advantageous when a valve was closed and is then initially partially opened by the actuating process. The hot medium that is now flowing allows the energy converter to generate more energy than in the previous completely closed state. This is the case when a valve, such as a radiator valve, is opened within a hot-water pipe. This means the actuating command can thus be completed sooner.

On the other hand, if the amount of energy within the energy storage unit 7 is insufficient, a partial actuating process should not take place if the energy to be gained is expected to thereby decrease. This is the case, for example, when a valve is to be closed.

Particularly in the event, for instance, that a thermal valve is to be completely closed in accordance with a command, a check is made to see whether there is sufficient energy within the energy storage unit 7 to allow not only the closing process, but also any subsequent opening process to be carried out completely or at least in part.

The main difference to the prior art is that energy is continually collected by the energy converter and the actuating process can be completed on its own without the need for any external intervention in the system. Here, an undefined state can no longer occur in the system. Not even in the event that the energy converter is unable to collect any additional energy for the completion of the actuating process.

In the case of a radiator valve 1, but also applying generally for actuators, an actuating process is often followed by a recovery process in the opposite direction. For example, a valve is opened and when a requirement has been fulfilled, it is closed again. In a preferred development on the invention, the control takes this fact into account in that the actuating process is only carried out if the recovery process can also be carried out with the amount of energy currently available in the energy storage unit. Here, the amount of energy that would most likely be generated by the energy converter between the actuating processes is not taken into account for reasons of safety. Alternatively, this amount of energy may also be taken into account, which means that the actual amount of energy available can be smaller by this expected yield than the amount of energy needed for the recovery process.

Alternatively, an actuating process is only carried out when there is sufficient energy available in the energy storage unit 7 for the actuating process and any movement of the actuator to an emergency or starting position if needs be. This could involve, for example, the complete opening or closing of a valve. This means that an actuating command for a half or three-quarter opening would only be carried out if sufficient energy is additionally available, for example, to subsequently completely close or to reopen the valve. This goes to ensure reliable operation of the device even in an error or emergency situation.

The method may also have an emergency cutout in that the amount of energy available in the energy storage unit is continuously subjected to a trend. For example, if the amount of energy continuously falls this could suggest a problem with the energy converter. In this event, the remaining amount of energy available in the energy storage unit can be used to move to an emergency or starting position of the actuator and a warning taking the form of an error signal issued. Here again, the system remains in a defined state. Moreover, it is advantageous to issue an error message when the actual energy consumption is significantly higher than the estimated, which could suggest a blockage of the valve, for instance.

### REFERENCE LIST

1 Radiator valve

2 Control device

3 Actuator

4 Energy converter

5 Ambient energy source

6 Voltage converter

7 Energy storage unit

8 Central computer/energy quantity meter

9 Communication module

10 Control unit

11 Temperature sensor

12 Passive mode

13-26 Process steps

1. A method for operating an electrically driven actuator having a power supply that has an energy storage unit, comprising first determining an amount of energy available in the energy storage unit (16), and carrying out an actuating process only when there is sufficient energy in the energy storage unit to carry out the actuating process in full (17).

2. The method according to claim 1, wherein to determine the available amount of energy, the method further comprises an energy quantity meter continuously adding up the amount of energy stored in and withdrawn from the energy storage unit.

3. The method according to claim 1, wherein the amount of energy required for the actuating process is filed in a table.

4. The method according to claim 1, further comprising determining the amount of energy needed for an actuating process during a first implementation of the process or at fixed intervals and storing a determined value in a table for later use.

5. The method according to claim 1, further comprising generating an error message when the amount of energy needed for the actuating process is greater than the stored amount of energy.

6. The method according to claim 1, further comprising carrying out an actuating process only when there is enough additional energy available in the energy storage unit for a recovery process of the actuator.

7. The method according to claim 1, further comprising carrying out an actuating command only if there is enough additional energy available in the energy storage unit for any subsequent actuating movement to an emergency or starting position.

8. The method according to claim 1, further comprising that if there is not a sufficient amount of energy in the energy storage unit, delaying implementation of the actuating process until enough energy is available in the energy storage unit.

9. A method for operating an electrically driven actuator having a power supply that has an energy storage unit, comprising first determining an amount of energy available in the energy storage unit (21), and if there not a sufficient amount of energy in the energy storage unit, carrying out a partial implementation of the actuating process (24) and then when there is a sufficient amount of energy in the energy storage unit completing the implementation.

10. The method according to claim 9, wherein the partial implementation (24) only takes place when an expected energy yield of an energy converter thereby increases, thus allowing the actuating process to be completed sooner.

11. A device for operating an electrically driven actuator (3) comprising a power supply that has an energy storage unit (7), an energy quantity meter (8) that monitors an amount of electrical energy available in the energy storage unit and a control device configured such that an actuating process is only carried out when sufficient energy is available in the energy storage unit (7) to carry out the actuating process in full.

12. A device according to claim 11, wherein the device has an energy converter (4) for converting ambient energy (5) into electrical energy, the energy generated is adapted to be stored in the energy storage unit (7) and the energy quantity meter (8) is adapted to monitor the amount of energy stored in and withdrawn from the energy storage unit (7).
